(19) United States
(12) Patent Application Publication
(10) Pub. No.: US 2018/0330646 A1
(43) Pub. Date: Nov. 15, 2018

(54) FLAG WITH FASTENER SYSTEM

(71) Applicant: James MILLER, Lawton, MI (US)

(72) Inventor: James MILLER, Lawton, MI (US)

(21) Appl. No.: 15/969,927

(22) Filed: May 3, 2018

Related U.S. Application Data
(60) Provisional application No. 62/503,393, filed on May 9, 2017.

(51) Int. Cl. G09F 17/00

(52) U.S. Cl. CPC G09F 17/00; A44B 18/008; G09F 2017/005

(57) ABSTRACT

Flags that include a body and a fastener system including a first sheet having a plurality of hook fasteners on at least one side thereof and a second sheet having a plurality of loop fasteners on at least one side thereof. The first and second sheets are secured to the body along an edge thereof and each protrudes therefrom. The two sheets are configured to wrap around a support structure such that the hook and loop fasteners are coupled and the two sheets form a sleeve that encloses a portion of the support structure and removably secures the body to the support structure.

### CROSS REFERENCE TO RELATED APPLICATIONS

This application claims the benefit of U.S. Provisional Application No. 62/503,393 filed May 9, 2017, the contents of which are incorporated herein by reference.

### BACKGROUND OF THE INVENTION

The present invention generally relates to flags, pendants, banners, and the like (collectively referred to herein as flags). The invention particularly relates to flags configured to be removably secured to support structures.

Many types of flags are available including those with integrated fasteners for securing the flag to a support structure such as a flag poll. The structure of these fasteners is often a compromise between promoting a secure connection to a support structure and promoting ease of coupling and uncoupling the flag from the support structure. As such, there is an ongoing desire for a flag having an integrated fastener that was capable of convenient use while providing a secure connection.

### BRIEF DESCRIPTION OF THE INVENTION

The present invention provides flags suitable for quickly and easily attaching to a support structure while providing a secure connection thereto.

According to one aspect of the invention, a flag is provided that includes a body and a fastener system including a first sheet having a plurality of hook fasteners on at least one side thereof and a second sheet having a plurality of loop fasteners on at least one side thereof. The first and second sheets are secured to the body along an edge thereof and each protrudes therefrom. The two sheets are configured to wrap around a support structure such that the hook and loop fasteners are coupled and the two sheets form a sleeve that encloses a portion of the support structure and removably secures the body to the support structure.

Technical effects of the flag described above preferably include the capability of removably securing the flag to various support structures quickly and easily.

Other aspects and advantages of this invention will be further appreciated from the following detailed description.

### BRIEF DESCRIPTION OF THE DRAWINGS

FIG. 1 schematically represents a side view of a flag configured to be secured to a support structure in accordance with nonlimiting aspects of the present invention.

FIGS. 2 and 3 schematically represent isolated views of a hook and loop fastener system of the flag of FIG. 1 along edges thereof.

FIG. 4 schematically represents the flag of FIG. 1 during use.

### DETAILED DESCRIPTION OF THE INVENTION

This disclosure provides a flag, banner, pendant, or similar structure (collectively referred to hereinafter as a flag) configured to be removably and securely attached to a support structure, such as but not limited to a shaft, pole, or other elongated body. Although the exemplary flag disclosed herein and shown in the figures is representative of a national flag for the United States of America, it will be understood that this disclosure is applicable to any type of flag including, but not limited to, national flags, decorative flags, informative flags, warning flags, etc. Such flags may have various shapes and content (e.g., various symbols, wording, pictures, color, etc.), and may be formed of various materials, such as but not limited to natural and/or synthetic cloth-like materials (e.g., flexible membrane). For convenience, the following discussion will be in reference to attachment of the flag to a cylindrical shaft, though it should be understood that the flag may be attached to support structures of various sizes and shapes.

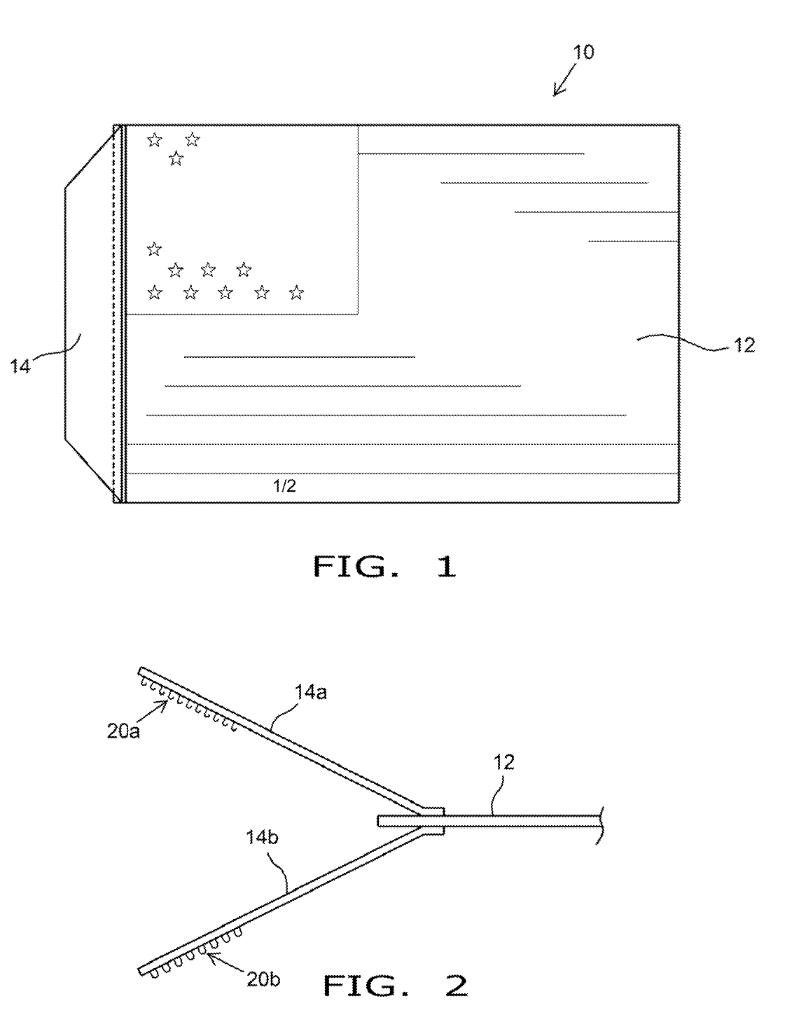

FIGS. 1 through 4 represent a nonlimiting embodiment of a flag 10 configured to be secured to an elongated shaft or other support structure. The flag 10 includes a flexible, rectangular body 12 of the type conventionally used for national flags, and a hook and loop fastener system 14 (e.g., VELCRO®) permanently secured along an edge of the body 12. FIG. 2 represents that the fastener system 14 includes two planar, flexible sheets 14a and 14b each secured to the body 12 of the flag 10 along an edge thereof and protrudes outward therefrom. The sheets 14a and 14b each include hooks 20a and/or loops 20b, respectively, on at least one side thereof.

These components may be arranged in a variety of configurations. For example, although FIG. 2 represents the hooks 20a on a side of the sheet 14a facing the sheet 14b, and the loops 20b on a side of the sheet 14b facing away from the sheet 14a, it will be understood that this arrangement may be reversed such that the hooks 20a and the loops 20b are located on opposite sides of their respective sheets 20a and 20b relative to that shown in the drawing. Further, the loops 20b may be located on the sheet 14a and the hooks 20a may be located on the sheet 14b.

In the nonlimiting embodiment shown, the sheets 14a and 14b overlap oppositely disposed sides of the body 12 adjacent the edge of the body 12 in order to strengthen a connection between the sheets 14a and 14b and the body 12. The sheets 14a and 14b may be secured to the body 12 by a wide variety of means, preferably in a manner sufficient to withstand forces applied to the flag 10 when in use due to wind and the like. According to one embodiment, the sheets 14a and 14b are secured to the body 12 with a seam sewn through both sheets 14a and 14b and the body 12. Alternatively, the sheets 14a and 14b may be individually secured to the body 12, for example, with sewn seams, an adhesive, or fasteners.

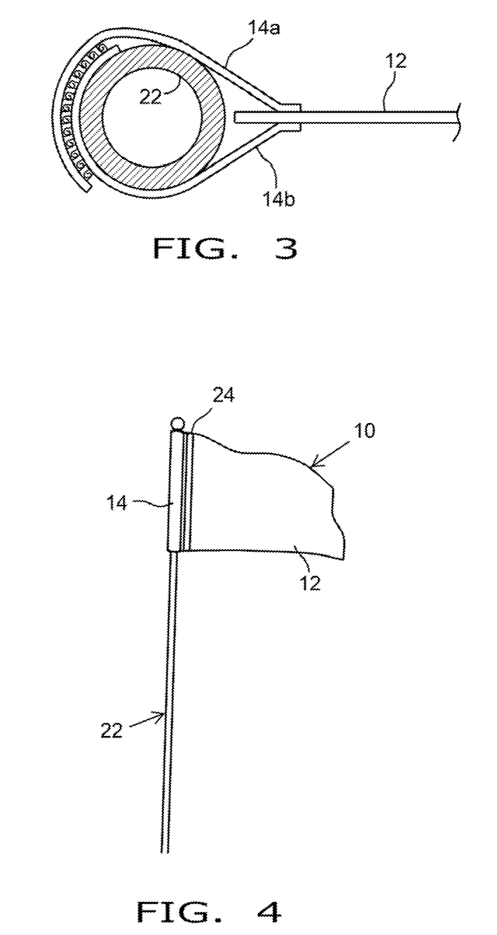

In use as shown in FIGS. 3 and 4, the two sheets 14a and 14b may be wrapped in opposite directions around a shaft 22 and overlapped with one another such that the hooks 20a and loops 20b contact and are secured to one another. In combination, the sheets 14a and 14b function to secure the body 12 of the flag 10 to the shaft 22. FIG. 3 represents the sheets 14a and 14b of the fastener system 14 coupled to define a sleeve that encloses a portion of the shaft 22. This arrangement is believed to promote ease of use when coupling and decoupling the flag 10 to a shaft. In addition, it is foreseeable that the sleeve may allow the flag 10 to be rotatable about the shaft 22.

Although not required, the fastener system 14 preferably extends along the entire length of the edge of the body 10 in order to increase the surface area of contact between the fastener system 14 and the body 12 as well as increase the amount of hooks 20a and loops 20b coupled to one another during use of the flag 10, thereby promoting the strength of each of these connections. Although not shown, an entire side of each sheet 14a and 14b may be covered with hooks 20a and/or loops 20b such that the sheets 14a and 14b may be overlapped by varying amounts to accommodate shafts of various size (for example, various diameters).

FIG. 4 represents the flag 10 secured to the shaft 22. Optionally, the flag 10 may include an additional layer 24 located between the body 12 and the hook and loop fastener system 14 in order to provide additional reinforcement of the edge of the flag 10. For example, the layer 24 may be formed of a material that is more resistant to tension and/or tearing relative to the material of the body 12. According to a specific nonlimiting embodiment, the flag 10 is particularly well suited to be releasably secured to a shaft located on the stern of a boat and configured to remain secured to the shaft during operation of the boat.

While the invention has been described in terms of specific or particular embodiments, it should be apparent that alternatives could be adopted by one skilled in the art. For example, the flag 10 and its components could differ in appearance and construction from the embodiments described herein and shown in the figures, and various materials could be used in the fabrication of the flag 10 and/or its components. Accordingly, it should be understood that the invention is not necessarily limited to any embodiment described herein or shown in the figures. It should also be understood that the phraseology and terminology employed above are for the purpose of describing the disclosed embodiments, and do not necessarily serve as limitations to the scope of the invention. Therefore, the scope of the invention is to be limited only by the following claims.

1. A flag comprising:
a body; and
a fastener system comprising a first sheet having a plurality of hook fasteners on at least one side thereof and a second sheet having a plurality of loop fasteners on at least one side thereof, the first and second sheets being secured to the body along an edge thereof and each protruding therefrom;
wherein the first and second sheets are configured to wrap around a support structure such that the hook and loop fasteners are coupled and the sheets define a sleeve that encloses a portion of the support structure and removably secures the body to the support structure.

2. The flag of claim 1, wherein the first and second sheets overlap the edge of the body.

3. The flag of claim 2, wherein the first and second sheets are secured to oppositely disposed sides of the body.

4. The flag of claim 1, wherein the first and second sheets are secured to oppositely disposed sides of the body.

5. The flag of claim 1, further comprising a layer between the body and the first and second sheets configured to reinforce the edge of the body.

6. The flag of claim 1, wherein the at least one side of the first sheet is entirely covered with the hook fasteners and the at least one side of the second sheet is entirely covered with the loop fasteners.
